(19) United States
(12) Patent Application Publication
(10) Pub. No.: US 2014/0002849 A1
(43) Pub. Date: Jan. 2, 2014

(54) IMAGE FORMING APPARATUS, WIRELESS CONNECTION SETTING METHOD, AND STORAGE MEDIUM

(71) Applicant: CANON KABUSHIKI KAISHA, Tokyo (JP)

(72) Inventor: Yukio Kanakubo, Yokohama-shi (JP)

(21) Appl. No.: 13/931,517

(22) Filed: Jun. 28, 2013

(30) Foreign Application Priority Data
Jul. 2, 2012 (JP) 2012-148853

(51) Int. Cl. G06F 21/31

(52) U.S. Cl. CPC G06F 21/31
USPC 358/1.14

(57) ABSTRACT

An image forming apparatus includes a generation unit configured to generate connection information for setting wireless connection, a storing unit configured to store the connection information generated by the generation unit in a storage unit, a print control unit configured to control a printing unit to print the connection information generated by the generation unit on a recording medium, and a reuse unit configured to, if security information is not transmitted from a wireless access point in a predetermined time, reuse the connection information stored by the storing unit in authenticating the connection information in the a next wireless connection setting and transmit the connection information to the wireless access point to authenticate the connection information.

### BACKGROUND OF THE INVENTION

1. Field of the Invention

The present invention relates to an image forming apparatus, a wireless connection setting method, and a storage medium.

2. Description of the Related Art

In recent years, a wireless local-area-network (LAN) communication function has been provided on a large number of information apparatuses including printing apparatuses. There have been increasing printing apparatuses provided with a wireless LAN communication interface and wirelessly connectable to a host computer.

A user need to have some level of knowledge of wireless LAN in order to set the security of the wireless LAN communication. However, it has been very difficult for the uninitiated to set the security thereof. Thus, a protocol for automating a complicated security setting of the wireless LAN has been defined. A Wi-Fi Protected Setup (WPS) system, which is a representative protocol system, has been widely used.

In the WPS, there are two types of recognition systems for connecting a device to a wireless LAN access point such as a push button system and a personal identification number (PIN) code system. The PIN code system is the one that a four- or eight-digit number called a PIN code generated by the device is input to the access point of a connection destination so that a device authentication and a connection setting (security setting) with the access point can be performed.

Some printing apparatuses do not have displays such as a liquid crystal display (LCD) for displaying a character string in the main body to reduce cost. Such a printing apparatus without the display cannot display the generated PIN code in executing the WPS using the PIN code system, so that the printing apparatus employs a system discussed in Japanese Patent Application Laid-Open No. 2007-223222 in which information required for setting is printed on a sheet of paper to make the user recognize the information.

If the PIN code is not input to the access point within a predetermined time period after the execution of the WPS using the PIN code system, a time-out occurs to fail in setting. This is operational specifications to shorten the period during which security problems such as inadequate connection from the outside may occur. If the time-out occurs in executing the WPS using the PIN code system, the WPS using the PIN code system needs to be executed again in the printing apparatus to continue the connection setting of the wireless LAN. At this point, it is general that the previous PIN code is discarded to generate a new PIN code.

### SUMMARY OF THE INVENTION

The present invention is directed to an image forming apparatus which improves usability in performing a wireless connection setting using connection information such as a PIN code.

According to an aspect of the present invention, an image forming apparatus includes a generation unit configured to generate connection information for setting wireless connection, a storing unit configured to store the connection information generated by the generation unit in a storage unit, a print control unit configured to control a printing unit to print the connection information generated by the generation unit on a recording medium, and a reuse unit configured to, if security information is not transmitted from a wireless access point within a predetermined period of time, reuse the connection information stored by the storing unit in authenticating the connection information in a next wireless connection setting and transmit the connection information to the wireless access point to authenticate the connection information.

Further features of the present invention will become apparent from the following description of exemplary embodiments with reference to the attached drawings.

### BRIEF DESCRIPTION OF THE DRAWINGS

FIG. 1 is a sequence diagram illustrating an example of security information setting procedures of wireless LAN with the WPS using the PIN code system.

FIG. 2 is a schematic diagram illustrating the internal configuration of a printer.

FIG. 3 is a block diagram illustrating an example of the hardware configuration of a printing apparatus.

FIG. 4 is a block diagram illustrating an example of the software configuration of a printer.

FIG. 5 is a flow chart illustrating an example of processing procedures in executing the WPS using the wireless LAN PIN code system according to a first exemplary embodiment of the present invention.

FIG. 6 is a chart illustrating an example of a printing result of a PIN code.

FIG. 7 is a flow chart illustrating an example of processing procedures in executing the WPS using the wireless LAN PIN code system according to a second exemplary embodiment of the present invention.

### DESCRIPTION OF THE EMBODIMENTS

Various exemplary embodiments, features, and aspects of the invention will be described in detail below with reference to the drawings.

### [Description of WPS Using PIN Code]

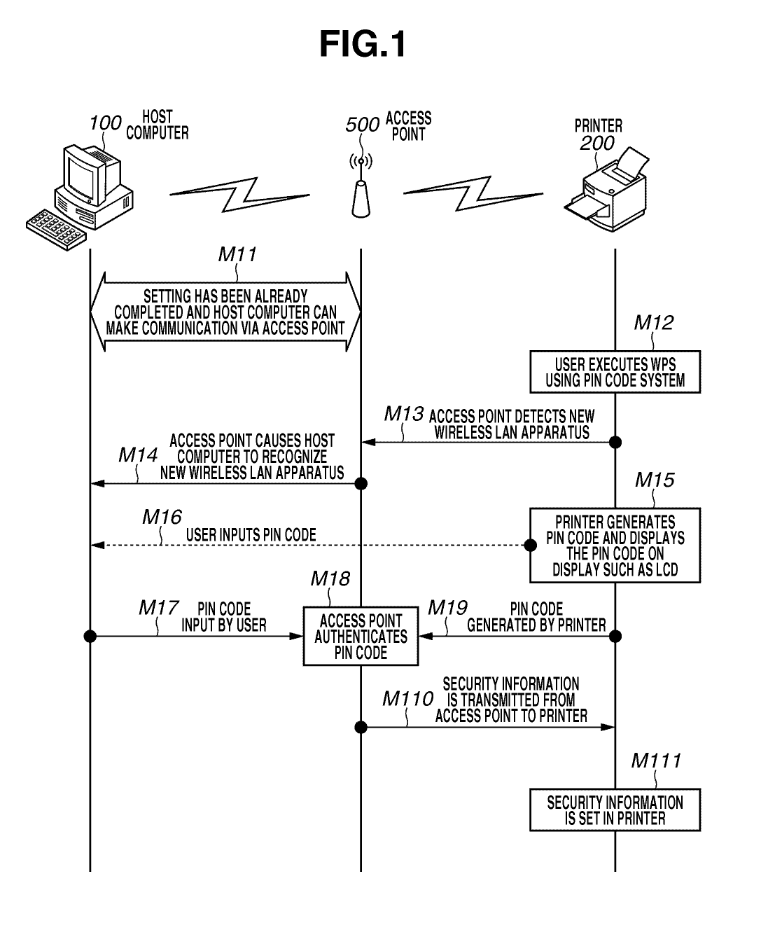

Before the description of a first exemplary embodiment, the security information setting procedures for the wireless LAN with the WPS using the PIN code system are described below with reference to a sequence diagram in FIG. 1.

In M11 in FIG. 1, the setting between a host computer 100 and an access point 500 has been already completed and the host computer 100 can make communication via the access point 500. The access point 50 host computer 100 0 is an example of a wireless access point. The host computer 100 is an example of an apparatus to perform wireless communication.

In M12, when the user executes the WPS using the PIN code system via the operation panel of a printer 200, then in M13, the access point 500, which supports the WPS, detects a new wireless LAN apparatus.

In M14, the access point 500 also causes the host computer 100 to recognize that the new wireless LAN apparatus is detected.

In M15, the printer 200 generates the PIN code and displays the PIN code on a display device of a panel such as an LCD.

In M16, the user inputs the PIN code via the set application in the host computer 100.

The access point 500 compares the PIN code input by the user (in M17) with the PIN code generated and transmitted by the printer 200 (in M19) to authenticate the PIN code (in M18). When the PIN code is authenticated (approval of apparatus), then in M110, security information (Service Set Identifier (SSID) and Wired Equivalent Privacy (WEP)/Wi-Fi Protected Access (WPA)) is transmitted from the access point 500 to the printer 200 and, in M111, the printer 200 sets the security information.

The wireless LAN security setting is automatically executed by the WPS using the PIN code system through the above procedures.

### [Description of Laser Beam Printer]

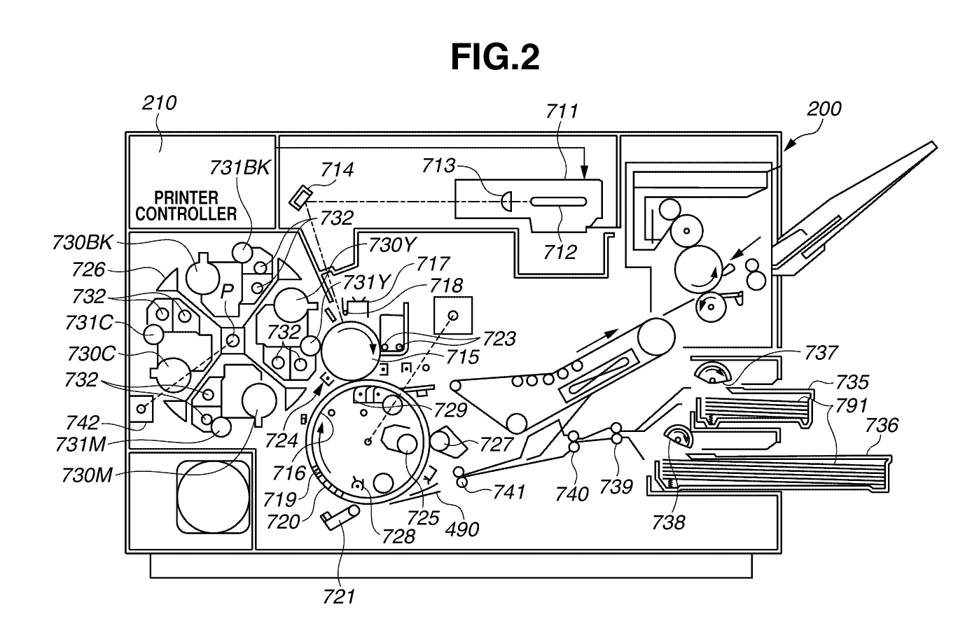

The internal configuration of a rotary-development laser beam printer to which the present exemplary embodiment is applied is described below with reference to FIG. 2. The printing apparatus is not limited to the rotary-development laser beam printer, but may be a tandem (four drums) laser beam printer or an ink jet printer.

In FIG. 2, a scanner 711 includes a laser output unit (not illustrated) for converting an image signal into a light signal, a polyhedral (octahedral, for example) polygon mirror 712, a motor (not illustrated) for rotating the polygon mirror 712, and a f/θ lens (imaging lens) 713. The laser beam emitted from the laser output unit is reflected by the side face of the polygon mirror 712 and linearly scans (raster scan) the face of a photosensitive drum 715 rotating in the direction indicated by an arrow in FIG. 2 via the f/θ lens 713 and a reflection mirror 714. This forms an electrostatic latent image corresponding to a document image on the face of the photosensitive drum 715. In the vicinity of the photosensitive drum 715 are arranged a primary charging device 717, a whole surface exposure lamp 718, a cleaner unit 723 for collecting residual toner that has not been transferred, and a pre-transfer charger 724. A development unit 726 develops the electrostatic latent image formed on the surface of the electrostatic latent image 715 by laser exposure and includes the following configuration. Development sleeves (731Y, 731M, 731C, and 731Bk) are in contact with the photosensitive drum 715 to directly perform development. Toner hoppers (730Y, 730M, 730C, and 730Bk) hold spare toner. A screw 732 transfers a developer. The sleeves (731Y, 731M, 731C, and 731Bk), the toner hoppers (730Y, 730M, 730C, and 730Bk), and the screw 732 are arranged around a central axis P of the development unit 726. Signs Y, M, C, and Bk added to the above components indicate color. In other words, Y, M, C, and Bk denote yellow, magenta, cyan, and black, respectively.

A development unit position sensor 742 detects the rotation position of the development unit 726. When a yellow toner image is formed, a yellow toner development processing is performed in the position illustrated in FIG. 2. When a magenta toner image is formed, the development unit 726 is rotated around the central axis P to cause the development sleeve 731M in the magenta development unit to contact the photosensitive drum 715. When cyan or black toner image is formed, a similar procedure is used. A transfer drum 716 transfers the toner image formed on the photosensitive drum 715 to paper. The paper is an example of a recording medium. An actuator board 719 detects the movement position of the transfer drum 716. A position sensor 720 is made close to the actuator board 719 to detect that the transfer drum 716 is moved to the home position. The actuator board 719, the position sensor 720, a transfer drum cleaner 725, a paper pressing roller 727, and a static eliminator 729 are a transfer charging device and arranged around the transfer drum 716. Sheet cassettes 735 and 736 store paper 791 (paper sheet). In the present exemplary embodiment, A-4 and A-3 size paper sheets are stored in the sheet cassettes 735 and 736, respectively. When paper is supplied, the paper is supplied from the sheet cassettes 735 and 736 by paper feeding rollers 737 and 738. Timing rollers 739, 740, and 741 determine timing of paper feeding and conveyance. The paper is guided by a paper guide 490 via the timing rollers, wound onto the transfer drum 716 with the leading edge thereof held by a gripper 728, and transferred to an image forming process. Whether to select the sheet cassette 735 or select the sheet cassette 736 is determined by an instruction of the controller unit 210 and only the selected paper roller is rotated. Full color printing in YMCK colors is realized by the above configuration.

### [Description of Printer Control System]

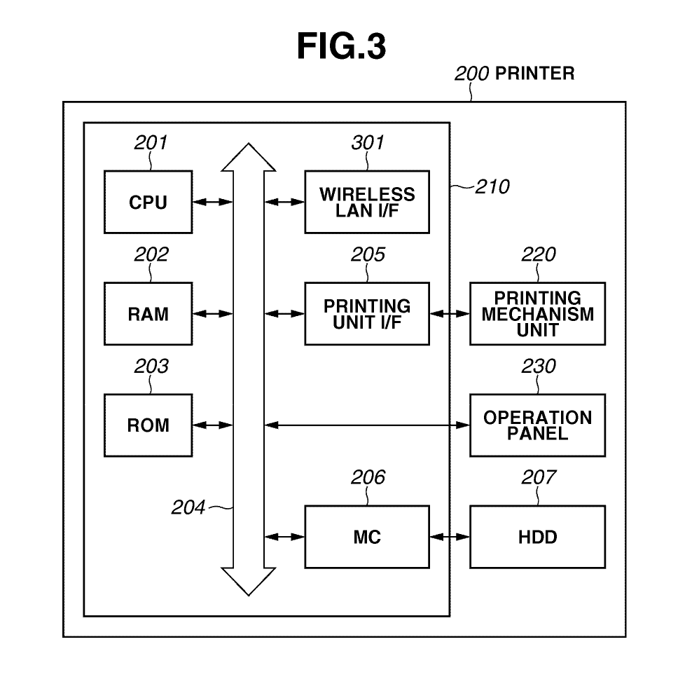

FIG. 3 illustrates an example of the hardware configuration of the printing apparatus. The following describes a rotary-development color laser beam printer (in FIG. 2) as an example.

In FIG. 3, the controller unit 210 is housed in the main body of the printer 200 and controls the operation of the entire printer.

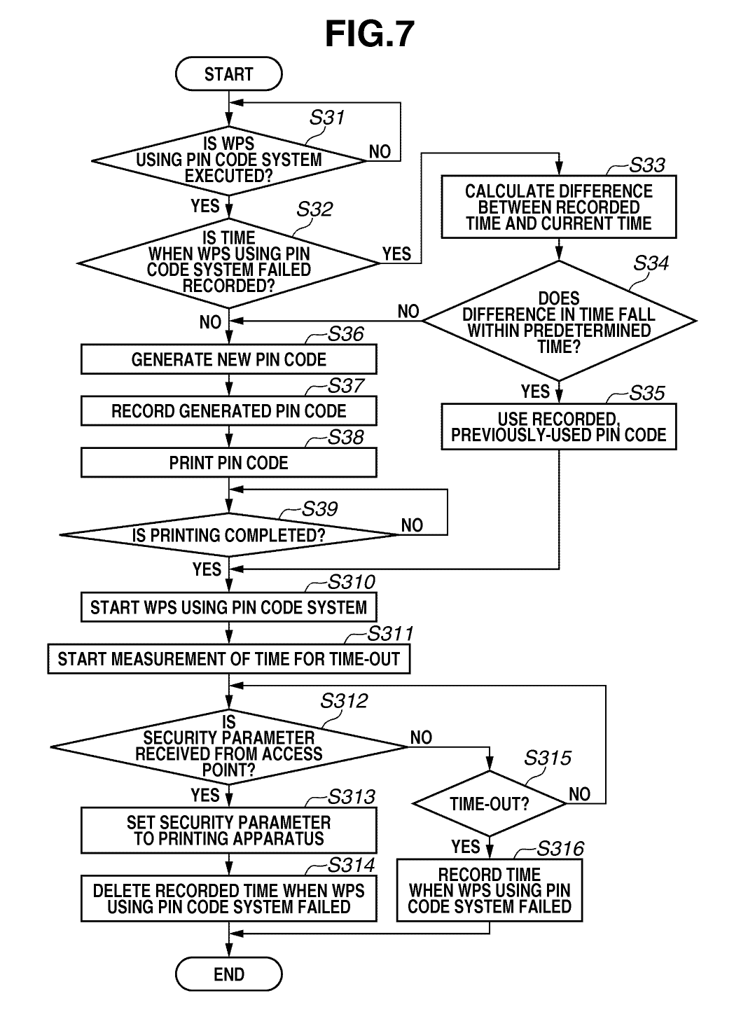

A CPU 201 generally controls access with various devices connected to a system bus 204 based on control programs stored in a read only memory (ROM) 203. The CPU 201 outputs an image signal as output information to a printing mechanism unit 220 connected via a printing unit interface (I/F) 205. The ROM 203 stores the control programs of the CPU 201 illustrated in a flow chart of FIG. 7. The CPU 201 is capable of communication processing with the access point 500 via a wireless LAN I/F 301 (or the host computer 100 via the access point 500) and of bidirectional communication with the access point 500.

A random access memory (RAM) 202 functions as the main memory and the work area of the CPU 201. The memory capacity of the printer 200 can be extended by an option RAM connected to an expansion port (not illustrated). The RAM 202 is used as a rendering memory for storing image data received from the host computer, a video signal ON/OFF information storage area, and other work areas. An operation panel 230 is provided with switches and a light emitting diode (LED) display for operating the printer. A memory controller (MC) 206 controls access with a hard disk 207 for storing print data received from the host computer. The RAM 202 is an example of a storage unit, for example.

The processing operation of the control unit in the printing apparatus with the above configuration according to the present exemplary embodiment is described below.

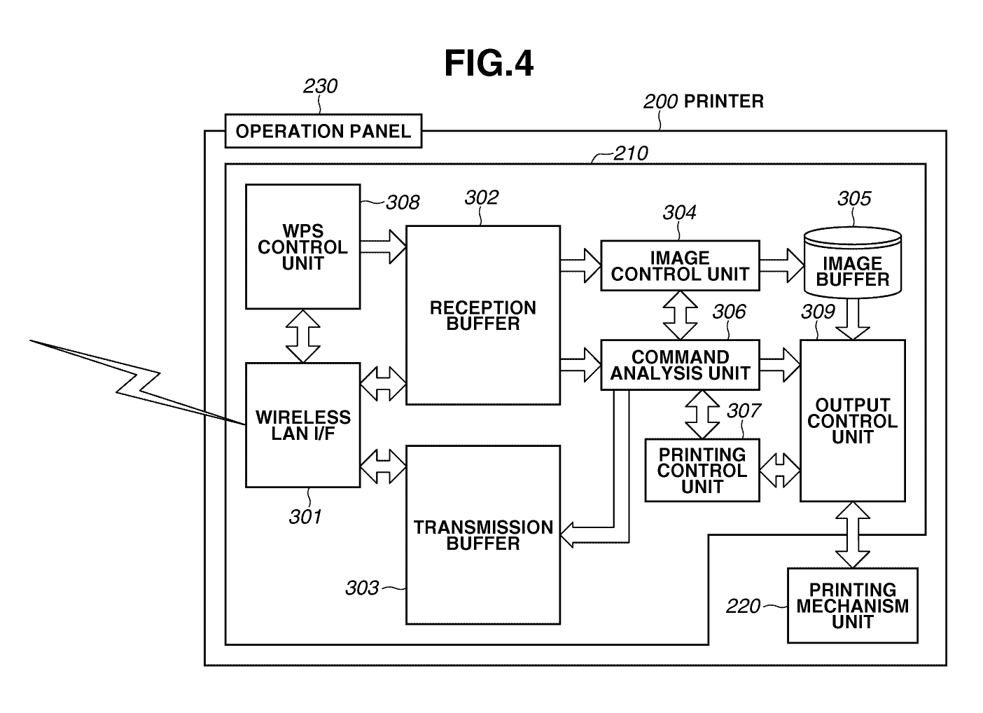

FIG. 4 illustrates an example of the software configuration of the printer 200.

The software configuration illustrated in FIG. 4 is realized by the CPU 201 executing the processing based on the programs stored in the ROM 203.

As illustrated in FIG. 4, the printer 200 includes a wireless LAN I/F 301, a reception buffer 302, a transmission buffer 303, an image control unit 304, an image buffer 305, a command analysis unit 306, a printing control unit 307, and a WPS control unit 308, as the software configuration. The printer 200 includes also an output control unit 309 as the software configuration.

The printer 200 is functionally and roughly formed of the controller unit 210, an operation unit 230, and a printing mechanism unit 220.

The controller unit 210 includes the wireless LAN interface (I/F) 301 capable of transmitting and receiving control commands and print data from the host computer 100 via the access point 500. The print data received via the wireless LAN interface (I/F) 301 are sequentially stored in the reception buffer 302 as a storing unit and read and processed by the command analysis unit 306 or the image control unit 304 as required. If there are data to be replied to the host computer as a result of command analysis by the command analysis unit 306, replay data are stored in the transmission buffer 303 and transmitted to the host computer by the wireless LAN interface (I/F) 301.

The command analysis unit 306 performs control processing according to each print control command system and a print job control language. The command analysis unit 306 processes a rendering command by giving an instruction to the image control unit 304 and processes a command other than the rendering command such as paper feed selection or a reset command by giving an instruction to the printing control unit 307.

The image control unit 304 removes a command portion from the transferred image data command, performs expansion processing if the command is compressed image data, and stores the generated bit map data in the image buffer 305.

The output control unit 309 converts the bit map data stored in the image buffer 305 into a video signal based on the instruction of the printing control unit 307 and outputs the video signal to the printing mechanism unit 220. The printing mechanism unit 220 is a mechanism for forming the received video signal on a recording paper and is referred to as a printer engine.

The WPS control unit 308 is a processing unit for executing automatic setting of the wireless LAN security by the WPS using the PIN code system.

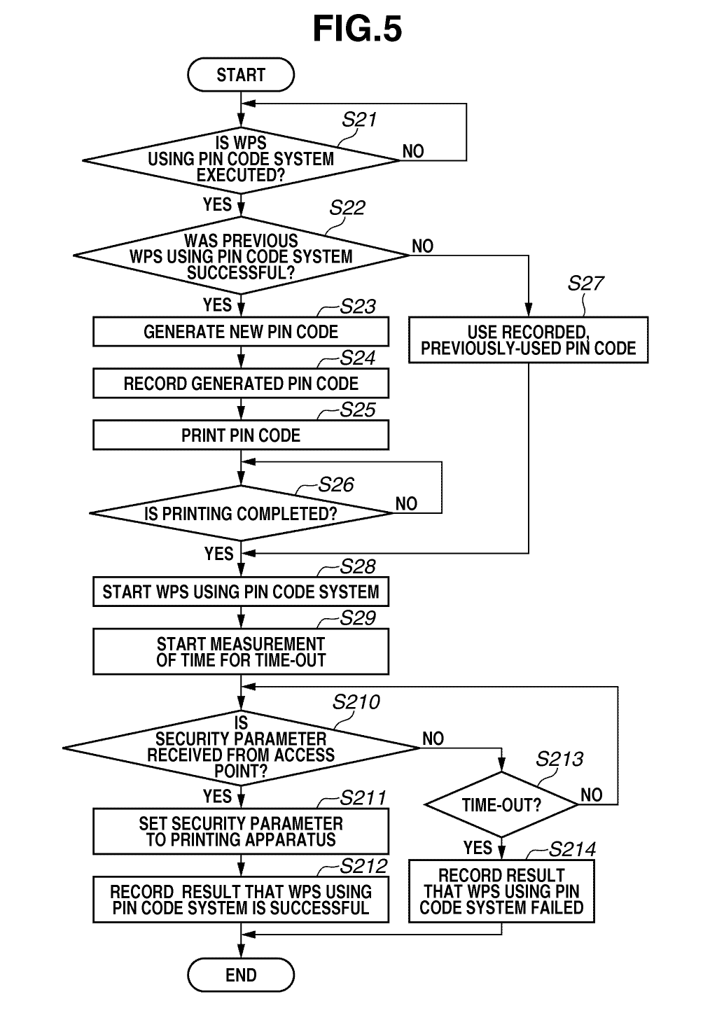

Processing procedures in executing the WPS using the wireless LAN PIN code system in the WPS control unit 308 are described below according to the flow chart in FIG. 5. The processing procedures are stored as programs in the ROM 203 and executed by the CPU 201.

In step S21, the WPS control unit 308 waits for the execution of the WPS using the PIN code system. The WPS control unit 308 determines whether the WPS using the PIN code system is executed based on a key operation on the operation panel of the printer. The determination is not limited to the above, but any method may be used.

If the WPS control unit 308 determines that the WPS using the PIN code system is executed (YES in step S21), the processing proceeds to step S22. In step S22, the WPS control unit 308 confirms the recorded result of the previous WPS execution using the PIN-code system. If the previous WPS using the PIN code system was successful (YES in step S22), the processing proceeds to step S23. In step S23, the WPS control unit 308 generates and uses a new PIN code.

In step S24, the WPS control unit 308 records the generated PIN code. The recorded PIN code is reused for the next WPS if the WPS using the PIN code system fails due to time-out.

In step S25, the WPS control unit 308 executes printing of the generated PIN code. In step S26, the WPS control unit 308 waits for the completion of printing.

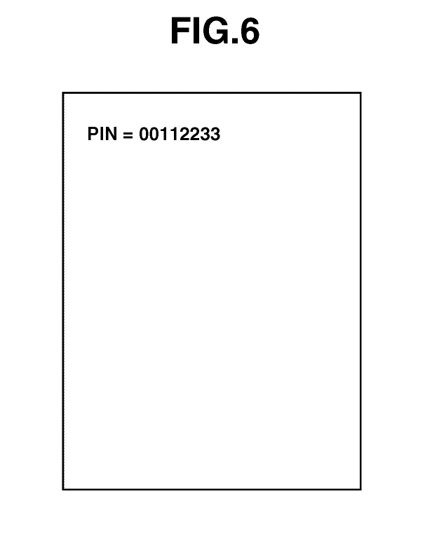

An example of the printing result of the PIN code is illustrated in FIG. 6.

On the other hand, if the previous WPS using the PIN code system failed (NO in step S22), the processing proceeds to step S27 and the WPS control unit 308 reuses the recorded, previously-used PIN code. When the value of the execution result of the previous WPS using the PIN code system is an initial value, i.e., when the WPS using the PIN code system is first executed, the previous WPS using the PIN code system is to be made successful.

In step S28, when the PIN code to be used is determined, the WPS control unit 308 starts the operation of the WPS using the PIN code system. More specifically, if the processing proceeds to step S28 through step S27, the WPS control unit 308 reuses the previous PIN code recorded (stored) in the RAM 202 to authenticate the PIN code and transmits the PIN code to the access point 500. When the WPS control unit 308 receives security information from the access point 500, the WPS control unit 308 sets the received security information.

In step S29, the WPS control unit 308 starts the measurement of time for time-out.

In step S210, the WPS control unit 308 waits for the transmission of the security parameter from the access point 500.

If the WPS control unit 308 receives the security parameter from the access point 500 in a predetermined period of time (YES in step S210), the processing proceeds to step S211. In step S211, the WPS control unit 308 sets the received security parameter to the printing apparatus. As a result, automatic setting with the WPS using the PIN code system become successful.

In step S212, the WPS control unit 308 records the result that the WPS using the PIN code system is successful. The security parameter of the wireless LAN refers to security setting parameters such as the SSID or the WEP/WPA key.

If the WPS control unit 308 does not receive the PIN code (NO in step S210), the processing proceeds to step S213. In step S213, the WPS control unit 308 determines whether time-out occurs. If the time-out is determined (YES in step S213), in step S214, the WPS control unit 308 records the result that the WPS using the PIN code system failed. Time for the time-out is not uniquely defined, but may be set by the user, for example.

According to the above description of the present exemplary embodiment, the WPS control unit 308 confirms the recorded result of the previous WPS execution using the PIN-code system when starting the execution of the WPS using the PIN code system. If the result of the previous execution indicates failure, the WPS control unit 308 reuses the recorded previously-used PIN code without generating a new PIN code and does not print the PIN code. Therefore, there is no need for re-printing a PIN code to execute the WPS again using the PIN code system, thereby achieving the effect of not consuming an additional sheet of paper.

Furthermore, since the PIN code is not changed only when the previous execution fails, the higher effect of improving the security can be obtained compared with an operation where the PIN code is set to a fixed value.

In the first exemplary embodiment, if the result of the previous execution of the WPS using the PIN code system indicates failure, the previously-used PIN code is reused. However, as long as failure continues, the same PIN code is repetitively used again and again. This is not appropriate in view of security. Even if the result thereof indicates failure one month ago, for example, the previous PIN code is reused. However, the paper on which the PIN code is printed is probably no longer kept. Thus, in a second exemplary embodiment, even if the result of the previous execution of the WPS using the PIN code system indicates failure, the previous PIN code is not reused, if a predetermined period of time elapses. In this case, a new PIN code is generated. The second exemplary embodiment is described below with reference to a flow chart illustrated in FIG. 7.

In step S31, the WPS control unit 308 waits for the execution of the WPS using the PIN code system.

If the WPS using the PIN code system is executed (YES in step S31), then in step S32, the WPS control unit 308 confirms whether the previous WPS using the PIN code system failed and whether the time when the WPS using the PIN code system failed is recorded. If the previous WPS using the PIN code system was successful (NO in step S32), the processing proceeds to step S36, and then the WPS control unit 308 generates a new PIN code.

In step S37, the WPS control unit 308 records the generated PIN code.

In step S38, the WPS control unit 308 executes the printing of the generated PIN code.

In step S39, the WPS control unit 308 waits for the completion of printing.

On the other hand, if the previous WPS using the PIN code system failed (YES in step S32), the processing proceeds to step S33, and then the WPS control unit 308 calculates the difference between the recorded failure time and the current time.

In step S34, the WPS control unit 308 compares the calculated difference in time with a predetermined time.

If the difference in time exceeds the predetermined period of time (NO in step S34), the processing proceeds to step S36. The WPS control unit 308 generates a new PIN code without reusing the previous PIN code.

If the difference in time is within the predetermined period of time (YES in step S34), the processing proceeds to step S35. The WPS control unit 308 reuses the recorded previous PIN code.

When the WPS using the PIN code system is first executed, the failure time is regarded as being deleted.

When the PIN code to be used is determined, then in step S310, the WPS control unit 308 starts the operation of the WPS using the PIN code system.

In step S311, the WPS control unit 308 starts the measurement of time for time-out.

In step S312, the WPS control unit 308 waits for the transmission of the security parameter from the access point 500.

If the WPS control unit 308 receives the security parameter from the access point 500 in a predetermined period of time (YES in step S312), the processing proceeds to step S313. In step S313, the WPS control unit 308 sets the received security parameter to the printing apparatus. As a result, automatic setting with the WPS using the PIN code system become successful.

In step S314, the WPS control unit 308 deletes the recorded time when the WPS using the PIN code system failed (to be a state without the record).

On the other hand, if the PIN code is not input (NO in step S312), then in step S315, the WPS control unit 308 determines whether time-out occurs. If the time-out is determined (YES in step S315), then in step S316, the WPS control unit 308 determines that the WPS using the PIN code system failed and records the current time (failure time).

As described above, in the present exemplary embodiment, the recorded time when the previous WPS using the PIN code system failed is confirmed when starting the WPS execution using the PIN code system. If the failure time is recorded, the difference between the failure time and the current time is calculated. If the time difference is within a predetermined period of time, the previously-used PIN code is used, and the PIN code is not printed. For this reason, there is no need for re-printing the PIN code to execute the WPS again using the PIN code system, thereby achieving the effect of not consuming an additional sheet of paper.

If the difference exceeds the predetermined period of time, the PIN code is generated again even though the WPS using the previous PIN code system failed, thus achieving the effect of reducing an inappropriate connection in terms of security.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the above exemplary embodiments, usability in setting a wireless connection using connection information about the PIN code can be improved, while unnecessary use of paper can be prevented.

The exemplary embodiments of the present invention are described in detail above. However, the present invention is not limited to such specific exemplary embodiments, but various variations and modifications thereof may be performed within the scope of the gist of the present invention according to the claims.

According to exemplary embodiments of the present invention, usability in setting a wireless connection using connection information about a PIN code can be improved and unnecessary use of paper can be prevented.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2012-148853 filed Jul. 2, 2012, which is hereby incorporated by reference herein in its entirety.

What is claimed is:

1. An image forming apparatus comprising:
a generation unit configured to generate connection information for setting wireless connection;
a storing unit configured to store the connection information generated by the generation unit in a storage unit;
a print control unit configured to control a printing unit to print the connection information generated by the generation unit on a recording medium; and
a reuse unit configured to, if security information is not transmitted from a wireless access point in a predetermined time, reuse the connection information stored by the storing unit in authenticating the connection information in a next wireless connection setting and transmit the connection information to the wireless access point to authenticate the connection information.

2. The image forming apparatus according to claim 1, wherein the print control unit controls the printing unit not to print the connection information stored by the storing unit in the next wireless connection setting.

3. The image forming apparatus according to claim 1, wherein the connection information is a personal identification number (PIN) code.

4. The image forming apparatus according to claim 1, wherein the generation unit generates the connection information if a user issues an instruction for setting a wireless connection.

5. The image forming apparatus according to claim 1, further comprising:
a recording unit configured to record a failure time if the security information is not transmitted by the wireless access point within the predetermined time because the connection information generated by the generation unit is not entered to an apparatus as a wireless communication partner,
wherein, if a difference between a current time and the time recorded by the recording unit is within a predetermined time, the reuse unit, when setting the next wireless connection, reuses the connection information stored by the storing unit and transmits the connection information to the wireless access point to authenticate the connection information.

6. The image forming apparatus according to claim 5, wherein, if the difference between the current time and the time recorded by the recording unit is not within the predetermined time, the generation unit generates new connection information for setting wireless connection when setting the next wireless connection.

7. A method for setting wireless connection executed by an image forming apparatus, the method comprising:
generating connection information for setting wireless connection;
storing the generated connection information in a storage unit;
controlling a printing unit to print the generated connection information on a recording medium; and
reusing, if security information is not transmitted from a wireless access point in a predetermined time, the stored connection information in authenticating the connection information in a next wireless connection setting and transmitting the connection information to the wireless access point to authenticate the connection information.

8. A computer readable storage medium storing a program that causes a computer to execute a method, the method comprising:
generating connection information for setting wireless connection;
storing the generated connection information in a storage unit;
controlling a printing unit to print the generated connection information on a recording medium; and
reusing, if security information is not transmitted from a wireless access point in a predetermined time, the stored connection information in authenticating the connection information in a next wireless connection setting and transmitting the connection information to the wireless access point to authenticate the connection information.
